(19) United States
(12) Patent Application Publication
(10) Pub. No.: US 2015/0114110 A1
(43) Pub. Date: Apr. 30, 2015

(54) Pneumatic Wheel Clamping Apparatus for a Wheel Service Machine

(71) Applicant: Hennessy Industries, Inc., LaVergne, TN (US)

(72) Inventors: James Marler, Greenbrier, TN (US); John Story, Murfreesboro, TN (US); Matthew Weis, Murfreesboro, TN (US)

(21) Appl. No.: 14/528,756

(22) Filed: Oct. 30, 2014

Related U.S. Application Data
(60) Provisional application No. 61/897,911, filed on Oct. 31, 2013.

(51) Int. Cl. B25B 11/00; G01M 1/16; G01M 1/04

(52) U.S. Cl. CPC B25B 11/00; G01M 1/045; G01M 1/16
USPC 73/460; 269/25

(57) ABSTRACT

An apparatus for a wheel service machine includes a body having an axis and a aperture through the axis, the aperture shaped to receive a rotary shaft, a first chamber and a second chamber located in the body, a pneumatic inlet communicated with the second chamber, the pneumatic inlet configured to be couple to a pneumatic supply line. A piston is movably disposed in the first chamber between a retracted and an extended position, the piston moving from the retracted position to the extended position when pressure from the second chamber is supplied to the first chamber. A valve is positioned between the first and second chambers, the valve selectively communicating the first and second chambers. A wheel service apparatus includes a base, a motor configured to rotate a rotary shaft, and a pneumatic nut. A docking station for the pneumatic nut can be located on the base.

A portion of the invention of this patent document contains material that is subject to copyright protection. The copyright owner has no objection to the reproduction of the patent document or the patent invention, as it appears in the U.S. Patent and Trademark Office patent file or records, but otherwise reserves all copyright rights whatsoever.

### CROSS-REFERENCES TO RELATED APPLICATIONS

This application claims benefit of U.S. Patent Application Ser. No. 61/897,911, filed Oct. 31, 2013, entitled Pneumatic Wheel Clamping Apparatus for a Wheel Balancing Machine.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to wheel service machines that may include a rotary shaft that rotates a vehicle wheel and tire assembly to be serviced or tested. Such machines include a base unit having a motor and a rotatable shaft connected to the motor. An object is placed on the shaft. The motor is turned on, the object rotates, and readings are taken which can test or determine one or more aspects of the object on the machine. One example of such a machine is a wheel balancing machine for vehicle wheels. A wheel and tire assembly can be secured to the rotary shaft. The motor can be activated, and measurements can be taken to determine whether the assembly is properly balanced. If the wheel is not balanced, compensating weights can be attached to the wheel. Properly balanced wheels improve a vehicle's drive performance.

More particularly, this invention pertains to a device or apparatus which can adequately secure a wheel to the rotatable shaft of a wheel balancer. Current attachment methods include a mechanical nut with radial levers that can be screwed onto the shaft until it engages the wheel rim tire, locking the wheel on the shaft. This solution requires a significant amount of time and energy to screw the nut down the shaft, and torque must be applied by hand to tighten the nut into a locking position. Another weakness with this solution is that the nut can loosen while the wheel is being tested, which can produce inaccurate test results, and additional time is required to retighten and retest the wheel.

Another conventional solution includes a pneumatic nut which can be locked onto the rotatable shaft. The pneumatic nut has a body with an internal chamber and a piston contained in the internal chamber, a portion of the piston extending out of the body. The pneumatic nut can be placed on the shaft of the wheel balancing machine. A pneumatic line can be coupled to the internal chamber in the pneumatic nut. The pneumatic line can pressurize the internal chamber with gas, forcing the piston to extend outward from the body, thereby locking the wheel on the wheel balancer shaft. The problem with such a solution is that the handling of a pneumatic line can be awkward and cumbersome as the user is trying to secure the wheel to the wheel balancer shaft.

What is needed, then, are improvements in wheel service machines and components for securing objects to rotary shafts of wheel servicing machines.

### BRIEF SUMMARY OF THE INVENTION

One aspect of the present invention is a pneumatic nut for use on a rotary shaft of a wheel service machine. The apparatus includes a body having an axis and an aperture through the body along the axis. The aperture is shaped to receive the rotary shaft. First and second chambers can be located in the body. A pneumatic inlet can be communicated with the second chamber. The pneumatic inlet can be configured to be coupled to a pneumatic supply line. A piston can be movably disposed in the first chamber between a retracted position and an extended position. The piston can have a piston rod extending out from the first chamber in a direction substantially parallel with the axis. The piston can move from the retracted position to the extended position when a pressure from the second chamber is supplied to the first chamber. In some embodiments a valve can be positioned between the first and second chambers, the valve selectively communicating the first chamber and the second chamber.

The second chamber can be pressurized to a predetermined pressure. A wheel and tire assembly can be positioned on the rotary shaft of the wheel service machine. The pneumatic nut can be positioned on the rotary shaft near the wheel and tire assembly. The valve can be actuated and a pressure from the second chamber can be supplied to the first chamber to move the piston to the extended position, the piston thereby engaging the wheel and tire assembly to secure the wheel and tire assembly on the rotary shaft so that tests can be performed on the wheel and tire assembly. Accordingly, the second chamber can be pressurized before being positioned on the rotary shaft, which can help eliminate the need for a pneumatic line to be coupled to the pneumatic nut while the pneumatic nut is positioned on the rotary shaft, which as previously noted can be cumbersome and awkward.

Another aspect of the present invention is a wheel service apparatus including a base, a motor mounted on the base, and a rotary shaft coupled to the motor. The apparatus can include a pneumatic nut including a body having an axis and aperture through the body along the axis, the aperture shaped to receive the rotary shaft. A first chamber and a second chamber can be located in the body, and a pneumatic inlet can be communicated with the second chamber. A piston can be movably disposed in the first chamber between a retracted position and an extended position, the piston moving from a retracted position to the extended position when a pressure from the second chamber is supplied to the first chamber. In some embodiments, the apparatus can further include a docking station located on the base, the docking station including a pneumatic supply and a nozzle communicated with the pneumatic supply, the nozzle configured to be selectively coupled to the pneumatic inlet of the pneumatic nut.

The pneumatic nut can be used to secure a wheel and tire assembly to the rotary shaft of the apparatus. After testing of the wheel and tire assembly, the pneumatic nut can be placed on the docking station with the nozzle coupled to the pneumatic inlet of the pneumatic nut. As such, the second chamber can be pressurized in preparation for the next test cycle. The pneumatic nut can therefore quickly and efficiently be charged or pressurized in between uses without the need of a separate pneumatic line or hose.

One object of the present invention is to provide an apparatus that can quickly and efficiently secure a wheel and tire assembly to a rotary shaft of a wheel service machine.

Another object of the present invention is to provide a wheel service apparatus which includes a pneumatic nut and a docking station which can quickly and efficiently charge or pressurize the pneumatic nut between uses.

Numerous other objects, advantages and features of the present invention will be readily apparent to those of skill in the art upon a review of the following drawings and description of a preferred embodiment.

### BRIEF DESCRIPTION OF THE SEVERAL VIEWS OF THE DRAWINGS

FIG. 1 is a perspective view of an embodiment of a pneumatic nut in accordance with an aspect of the present invention.

FIG. 2 is a cross sectional view of the pneumatic nut of FIG. 1 showing a valve in a first position preventing communication between first and second chambers.

FIG. 3 is a cross sectional view of the pneumatic nut of FIG. 1 showing a valve in a second position allowing communication between first and second chambers.

FIG. 4 is a cross-sectional view of the pneumatic nut of FIG. 1 showing a piston in an extended position.

FIG. 5 is a cross-sectional view of the pneumatic nut of FIG. 1 showing a locking member in an engaged position with a threaded shaft.

FIG. 6 is a cross-sectional view of the pneumatic nut of FIG. 1 showing a locking member in a disengaged position with a threaded shaft.

FIG. 7 is a detailed cross-sectional view of the pneumatic nut of FIG. 1 showing a pneumatic inlet with a check valve.

FIG. 8 is an exploded view of the pneumatic nut of FIG. 1.

FIG. 9 is a perspective cutaway view of an embodiment of a wheel service apparatus having a pneumatic nut.

FIG. 10 is a detailed view of a second embodiment of a wheel service apparatus having a pneumatic nut.

FIG. 11 is a partial cross sectional view of the wheel service apparatus of FIG. 9.

### DETAILED DESCRIPTION

While the making and using of various embodiments of the present invention are discussed in detail below, it should be appreciated that the present invention provides many applicable inventive concepts that is embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The term “lateral” denotes a side to side direction when facing the “front” of an object.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the devices and/or methods disclosed and claimed herein may be made and/or executed without undue experimentation in light of the present invention. While the devices and methods of this invention have been described in terms of the embodiments included herein, it will be apparent to those of ordinary skill in the art that variations may be applied to the devices and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

One aspect of the present invention is a pneumatic nut apparatus for use on a rotary shaft of a wheel service machine. The pneumatic nut can be clamped onto the rotary shaft of a wheel service machine to lock an object such as a wheel and tire assembly onto the rotary shaft. One such wheel service machine is a wheel balancing machine that uses a rotary shaft to rotate the wheel and tire assembly being balanced.

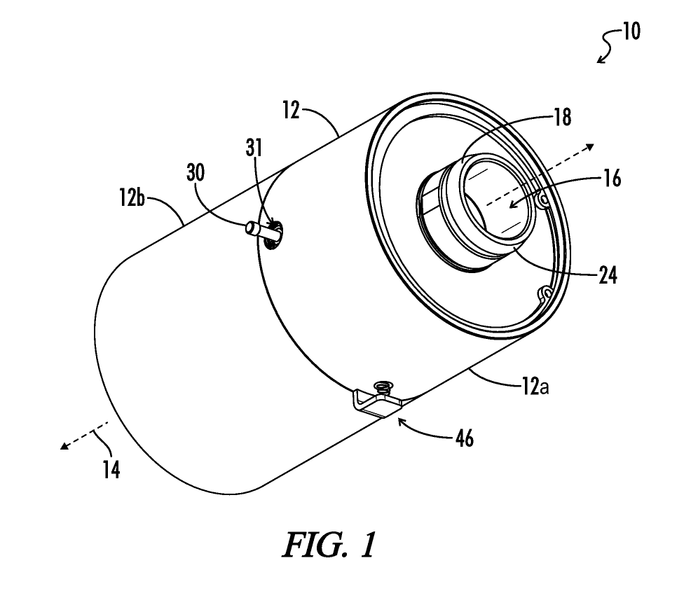

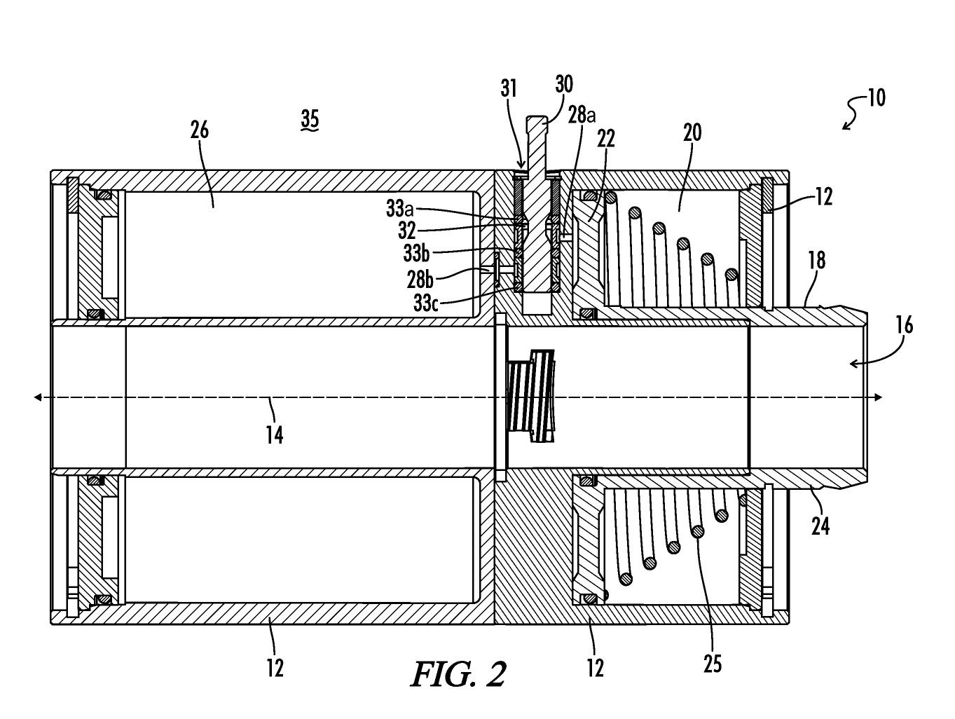

One embodiment of a pneumatic nut apparatus 10 is seen in FIG. 1. Pneumatic nut 10 includes a body 12 having a central axis 14. A hole or cylindrical aperture 16 extends through body 12 along axis 14. Aperture 16 can be shaped to receive a rotary shaft of a wheel service machine. Piston 18 can be movably disposed in body 12. A cross-sectional view of pneumatic nut 10 of FIG. 1 is shown in FIG. 2. Body 12 has a first chamber 20. Piston 18 can be movably disposed within first chamber 20 between a retracted position and an extended position. Piston 18 is shown in the retracted position in FIG. 2. Piston 18 in some embodiments can have a piston head 22 movably disposed in first chamber 20, and a piston rod 24 which can extend out of first chamber 20 in a direction substantially parallel with axis 14. In some embodiments, piston 18 can be biased in the retracted position. A retaining spring 25 can be positioned between piston head 22 and body 12. Retaining spring 25 can then bias piston 18 in the retracted position within first chamber 20.

A second chamber 26 can be located in body 12. First and second chambers 20 and 26 can be located in body 12 about aperture 16. In some embodiments, first and second chambers 20 and 26 can have a tubular or cylindrical shape, each of first and second chambers 20 and 26 having a longitudinal axis that is substantially collinear with axis 14 of body 12. Second chamber 26 can be selectively communicated with first chamber 20 such that a pressure from second chamber 26 can be selectively supplied to first chamber 20. Piston 18 can move from the retracted position to the extended position when a pressure from second chamber 26 is supplied to first chamber 20.

In some embodiments, a valve 30 can be located between first chamber 20 and second chamber 26. Valve 30 can be used to selectively communicate first chamber 20 with second chamber 26. Valve 30 can be positioned in aperture 31 in body 12 extending between first chamber 20 and second chamber 26. A first passageway 28a can extend from aperture 31 to first chamber 20. A second passageway 28b can extend from aperture 31 to second chamber 26. First and second passageways 28a and 28b can be offset from each other such that valve 30 can move within aperture 31 between a first position and a second position to selectively communicate first and second passageways 28a and 28b, and thereby communicate first and second chambers 20 and 26. In some embodiments, first, second, and third O-rings 33a, 33b, and 33c can be positioned in aperture 31, O-rings 33a, 33b, and 33c forming one or more dynamic seals with valve 30 as valve 30 moves within aperture 31. First and second O-rings 33a and 33b can be positioned about first passageway 18a, and second and third O-rings 33b and 33c can be positioned about second passageway 28b.

Valve 30 can be disposed in aperture 31 on body 12. Valve 30 is movable between a first position and a second position. Valve 30 substantially prevents fluid communication between first and second chambers when valve 30 is in the first position and allows fluid communication between first and second chambers when valve 30 is in the second position. Additionally, valve 30 in the first position can communicate first chamber 20 with an exterior 35 of apparatus 10. Valve 30 in the second position can substantially prevent communication between the first chamber 20 and an exterior 35 of apparatus 10.

As can be seen from FIG. 2, valve 30 can include an annular groove 32. With valve 30 in a first position, as shown in FIG. 2, valve 30 can substantially prevent communication between first chamber 20 and second chamber 26. The sidewalls of valve 30 form seals with second and third O-rings 33b and 33c on either side of second passageway 28b, such that gas can be prevented from escaping from second chamber 20, whether to first chamber 20 or to an exterior 35 of apparatus 10. Additionally, in the first position as shown in FIG. 2, annular groove 32 of valve 30 is positioned such that a space about annular groove 32 is communicated with first passageway 28a. Annular groove 32 also straddles first O-ring 32 such that first passageway 28a and first chamber 20 can be communicated with an exterior 35 of apparatus 10. As such, first chamber 20 is not pressurized and retaining spring 25 can keep piston 18 in the retracted position.

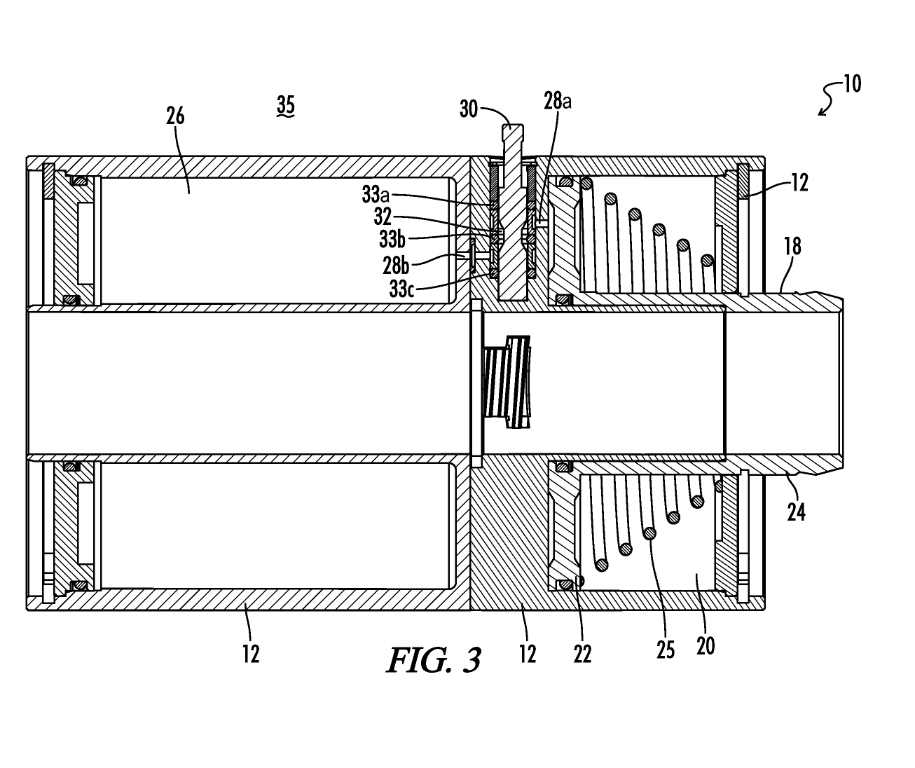

Valve 30 is shown in a second position in FIG. 3. In the second position, the sidewalls of valve 30 form seals with first and third O-rings 33a and 33c, while the annular groove 32 straddles second O-ring 33b. As such, pressurized gas from second chamber 26 can pass through second passageway 28b, the annular groove 32, and the first passageway 28a to communicate first chamber 20 with second chamber 26. Additionally, with valve 30 in a second position, first chamber 20 is closed to atmospheric air as first O-ring 33a forms a seal above first passageway 28a. Thus with valve 30 in the second position, communication between first chamber 20 and an exterior 35 of apparatus 10 is substantially prevented.

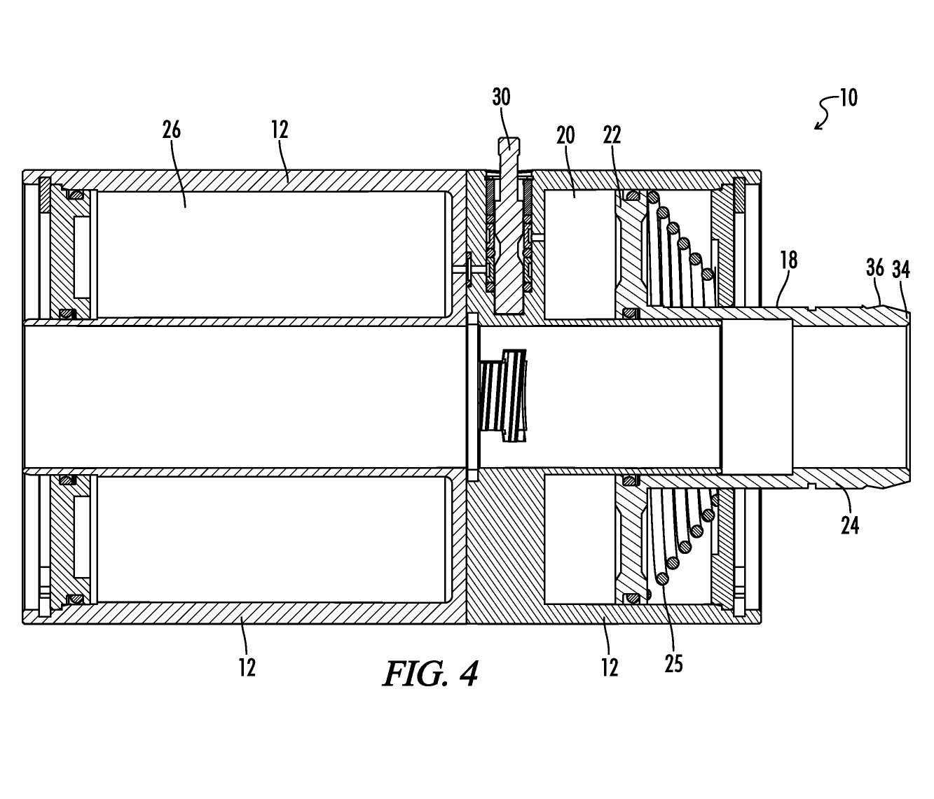

As can be seen in FIG. 4, when valve 30 is moved from a first position to a second position, and first chamber 20 is communicated with second chamber 26, a pressure or pressurized gas from second chamber 26 can be supplied through valve 30 into first chamber 20. The pressure being supplied to first chamber 20 can cause piston 18 and piston head 22 to compress retaining spring 25, and piston 18 can move from a retracted position to an extended position, as shown in FIG. 4. When pneumatic nut 10 is positioned on the rotary shaft of a wheel servicing machine, piston 18 moving from a retracted position to an extended position can cause distal end 34 of piston rod 24 to engage a wheel and tire assembly located on the rotary shaft. Consequently, pneumatic nut 10 can effectively clamp a wheel and tire assembly to the rotary shaft of the wheel servicing machine. In some embodiments, distal end 34 of piston rod 24 can be tapered such that as distal end 34 engages a wheel and tire assembly, a tapered surface 36 can effectively wedge against the wheel and tire assembly.

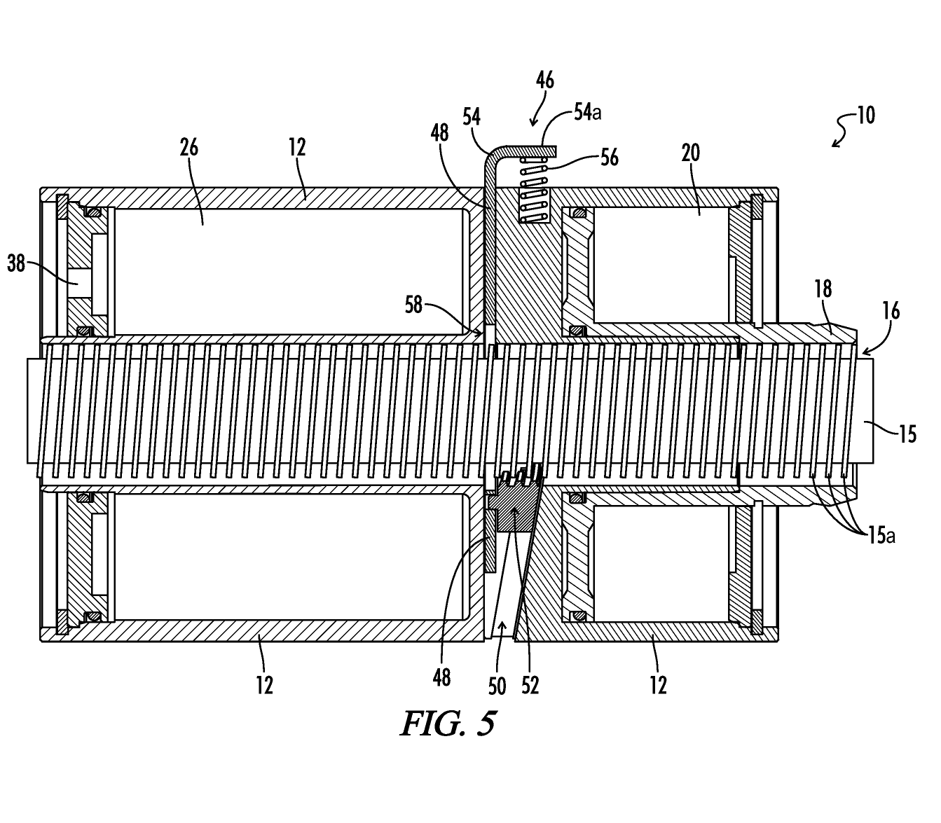

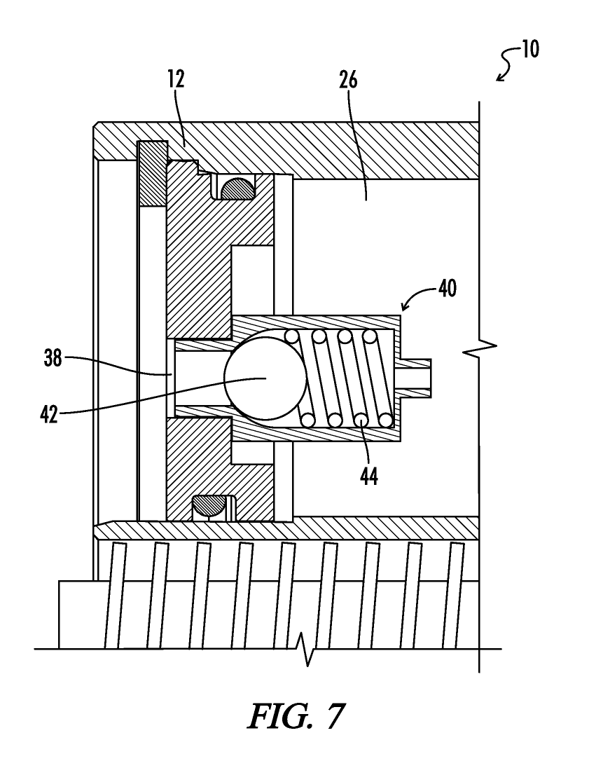

A second cross-sectional view of pneumatic nut 10 of FIG. 1 is shown in FIG. 5. Pneumatic nut 10 can further include a pneumatic inlet 38 communicated with second chamber 26. Pneumatic inlet 38 can be configured to couple to a pneumatic supply line or hose. As such, a pneumatic supply line can be coupled to pneumatic inlet 38 to supply pressurized gas to second chamber 26 and effectively pressurize or charge second chamber 20. As illustrated in FIG. 7, pneumatic inlet 38 in some embodiments can further include a check valve 40. Check valve 40 can include a stop 42 and a check valve spring 44. The check valve spring 44 biases stop 42 such that pneumatic inlet 38 is closed. As gas is supplied to pneumatic inlet 38, the gas forces stop 42 to compress check valve spring 44 and open pneumatic inlet 38 such that gas can be supplied to second chamber 26. Once a desired amount of gas is supplied to second chamber 26, the pneumatic supply line can be removed and check valve spring 44 can return stop 42 to a closed position over pneumatic inlet 38 such that gas in second chamber 26 can be substantially prevented from exiting through pneumatic inlet 38.

Pneumatic inlet 38 can include a one way check valve configured to prevent gases from exiting second chamber 26. In such an embodiment, when the valve is in the first position and communication is prevented between the first and second chambers 20, 26, check valve 40 can allow gas to be supplied and stored in second chamber 26. The ability of second chamber 26 to store a pressurized gas can allow second chamber to be charged or pressurized before pneumatic nut 10 is placed on a rotary shaft of a wheel service machine. This helps remove the need found in conventional solutions to first place a pneumatic nut on a rotary shaft and then connect a pneumatic supply line to the pneumatic nut while the pneumatic nut is on the wheel service machine. Handling a pneumatic line around a wheel service machine can be cumbersome and awkward, as well as time consuming. Thus, having a second chamber 26 that can be charged before pneumatic nut 10 is placed on a rotary shaft of a wheel service machine can help improve the efficiency and ease of the wheel service operation.

Referring again to FIG. 5, aperture 16 can be shaped to receive a rotary shaft 15 of a wheel service machine. Thus when pneumatic nut 10 is inserted onto a rotary shaft 15, rotary shaft 15 can be received by aperture 16. In some embodiments, pneumatic nut 10 can include a clamp assembly 46 disposed on body 12. Clamp assembly 46 can be configured to selectively secure pneumatic nut 10 to rotary shaft 15. In some embodiments, clamp assembly 46 can include a plate 48 movably disposed on body 12. Body 12 can include a channel 50 through body 12, and plate 48 can be disposed in channel 50. Plate 48 can be movably disposed in the channel 50 on body 12 between an engaged position and a disengaged position with rotary shaft 15. Plate 48 is shown in FIG. 5 in an engaged position with rotary shaft 15 when rotary shaft 15 is positioned in aperture 16. Plate 48 can be configured to prevent axial movement of pneumatic nut 10 and body 12 relative to rotary shaft 15 when plate 48 is in an engaged position with rotary shaft 15.

Many wheel service machines include a threaded rotary shaft 15. For such wheel service machines, plate 48 can be sized or configured to engage one or more threads 15a on rotary shaft 15. In other embodiments, plate 48 can further include one or more teeth 52 configured to engage threads 15a on rotary shaft 15. When the plate 48 or teeth 52 engage threads 15a on rotary shaft 15, pneumatic nut 10 can be prevented from moving axially relative to rotary shaft 15, or in other words, body 12 and pneumatic nut 10 can be prevented from sliding on rotary shaft 15. In some embodiments, plate 48 and teeth 52 are integrally formed as a unitary component. In other embodiments, teeth 52 can be located on a separate member that can be attached or connected to plate 48.

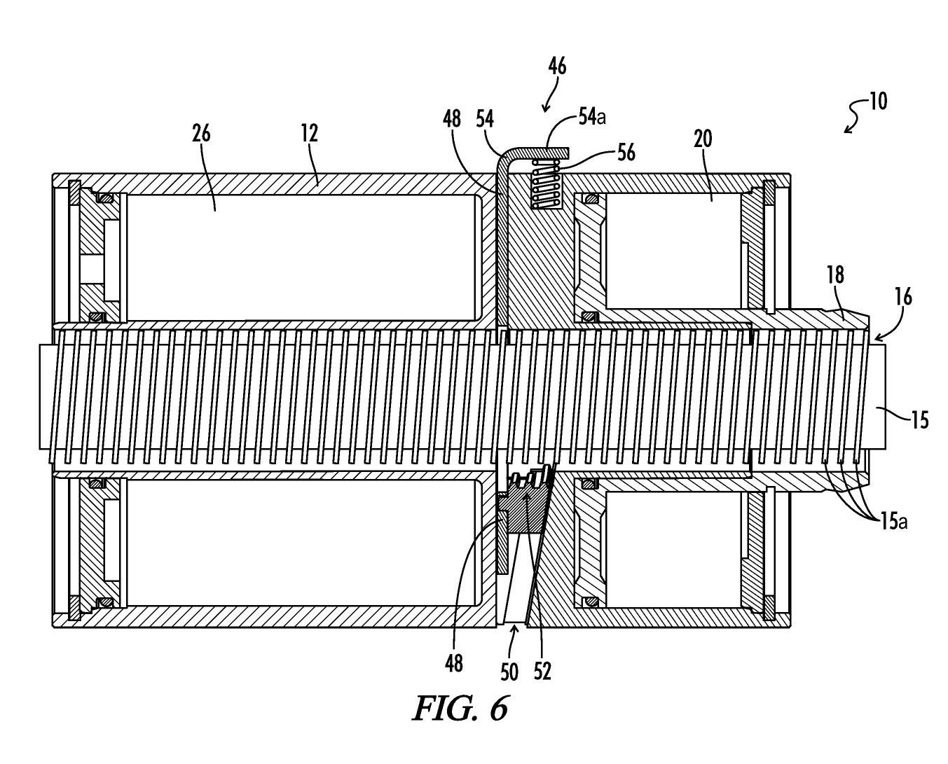

In some embodiments, plate 48 can include a push button 54 extending outward from body 12. In FIG. 5, push button 54 extends outward from body 12 and subsequently bends at a substantially ninety degree angle such that a contact portion 54a of push button 54 extends in a direction generally parallel with body 12. An operator can then depress push button 54 via contact portion 54a to move plate 48 from an engaged position, as shown in FIG. 5, to a disengaged position, as shown in FIG. 6, with rotary shaft 15. In some embodiments, a clamp spring 56 can be positioned between contact portion 54a of push button 54 and body 12. Clamp spring 56 can be configured to bias push button 54 in a raised position thereby biasing plate 48 and clamp assembly 46 in an engaged position with rotary shaft 15 when rotary shaft is positioned in aperture 16.

As can be seen from FIG. 6, when push button 54 is depressed and plate 48 moves from an engaged position to a disengaged position, clamp spring 56 is compressed. When push button 54 is subsequently released, clamp spring 56 can return push button 54 to a raised position and plate 48 to an engaged position with rotary shaft 15. As such, to insert pneumatic nut 10 onto a rotary shaft 15, an operator can depress push button 54 such that plate 48 moves to a disengaged position with rotary shaft 15. Pneumatic nut 10 can then be inserted onto rotary shaft 15 and moved to a desired position on rotary shaft 15. Once pneumatic nut 10 is in a desired position on rotary shaft 15, push button 54 can be released, and clamp spring 56 can return plate 48 to an engaged position with rotary shaft 15, thereby clamping pneumatic nut 10 to rotary shaft 15.

Clamp assembly 46 can be configured to securely clamp pneumatic nut 10 to rotary shaft 15 during the entire service operation without substantial slippage of pneumatic nut 10 on rotary shaft 15. As such, clamp assembly 46 can help ensure that a wheel and tire assembly being secured to rotary shaft 15 via pneumatic nut 10 also remains secured to the rotary shaft 15 during the wheel service operation without the wheel and tire assembly slipping or moving on rotary shaft 15. When a wheel and tire assembly slips or moves during the service operation, particularly when tests such as balancing are being performed, the slippage or movement of the wheel and tire assembly can affect the accuracy or the reliability of the tests, which often times requires the test to be redone. This is one problem associated with conventional manual nuts that can loosen during operation of the wheel servicing machine. Additional tests can take time and slow down the service operation of any given wheel and tire assembly.

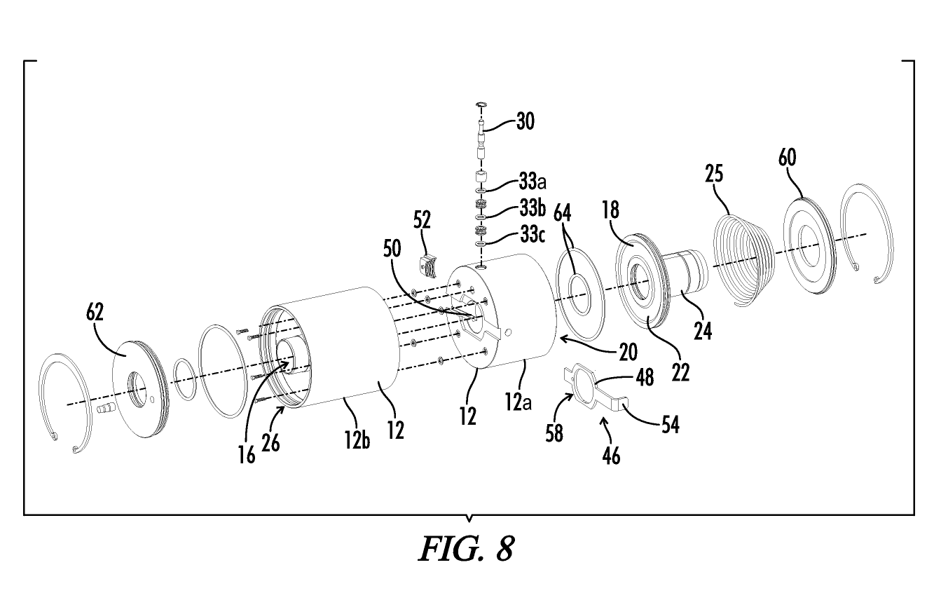

An exploded view of the pneumatic nut of FIG. 1 is shown in FIG. 8. In some embodiments, body 12 can include a first body portion 12a, a second body portion 12b, first end cap 60 and second end cap 62. First chamber 20 can be at least partially defined in first body portion 12a, and second chamber 26 can be at least partially defined in second body portion 12b. First end cap 60 can partially enclose first chamber 20, and second end cap 62 can partially enclose second chamber 26. The two body portions 12a and 12b can be connected together to form the overall body 12. Having body 12 include multiple pieces can help facilitate the manufacture or assembly of the pneumatic nut 10. In other embodiments, one or more of the pieces of the body 12 mentioned can be integrally formed together.

Channel 50 can be partially defined in either first or second body portions 12a and 12b such that when the two body portions 12a and 12b are connected together, channel 50 is formed. Plate 48 can be positioned between first and second body portions 12a and 12b, such that when first and second body portions 12a and 12b are connected together, plate 48 can be disposed in channel 50. Plate 48 can also include a plate aperture 58 such that when a rotary shaft is inserted through aperture 16 in pneumatic nut 10, the rotary shaft can also be received through plate aperture 58, as shown in FIG. 5.

Referring again to FIG. 8, piston 18 can be placed into first chamber 20. First end cap 60 can partially enclose first chamber 20, with piston rod 24 extending out of first end cap 60. Retaining spring 25 can be disposed about piston rod 24 such that retaining spring is located between piston head 22 and first end cap 60 of body 12. Pneumatic nut 10 can also include one or more piston O-rings 64 disposed on the head 22 of piston 18. The piston O-rings 64 produce a dynamic seal between piston head 22 and body 12 such that gas in first chamber 20 can be substantially prevented from leaking between piston head 22 and body 12 as piston 18 moves back and forth within first chamber 20.

Pneumatic nut 10 of FIG. 1 can provide an easy and efficient method to clamp a wheel and tire assembly on a rotary shaft of a wheel service machine. With the pneumatic nut removed from the rotary shaft and the valve in the first position preventing communication between the first and second chambers, the second chamber can be charged or pressurized by connected a pneumatic supply line to the pneumatic inlet. Once the second chamber is charged, an operator can place a wheel and tire assembly on the rotary shaft. The operator can depress the push button on the clamp assembly and move the plate to a disengaged position. The pneumatic nut can be inserted onto the rotary shaft and placed in a position on the rotary shaft with the distal end of the piston rod near the wheel and tire assembly. The push button can be released and the plate can move to an engaged position with the rotary shaft to clamp the pneumatic nut to the rotary shaft. The valve can then be actuated to move the valve to the second position. The first chamber can be communicated with the second chamber and the stored pressure in the second chamber can be supplied to the first chamber, thereby moving the piston from the retracted position to the extended position, the distal end of the piston rod engaging the wheel and tire assembly to clamp or secure the wheel and tire assembly to the rotary shaft.

A wheel service operation such as a wheel balance test can then be performed on the wheel and tire assembly. Once the operation or test is completed, valve 30 can be returned to the first position, thereby communicating the first chamber with an exterior of the apparatus and depressurizing the first chamber. The retaining spring can return the piston to the retracted position, such that the piston rod disengages the wheel and tire assembly. The push button on the clamp assembly can then be depressed to move the plate to a disengaged position with the rotary shaft. The pneumatic nut can then be removed from the rotary shaft, and the wheel and tire assembly can subsequently be removed from the rotary shaft. The wheel service operation can then be repeated for another wheel and tire assembly. The pneumatic nut can effectively clamp the wheel and tire assembly to the rotary shaft without a pneumatic line being connected to the pneumatic nut while the pneumatic nut is on the rotary shaft, which can help make the process easier and more efficient, as well as save time in clamping the wheel and tire assembly to the rotary shaft.

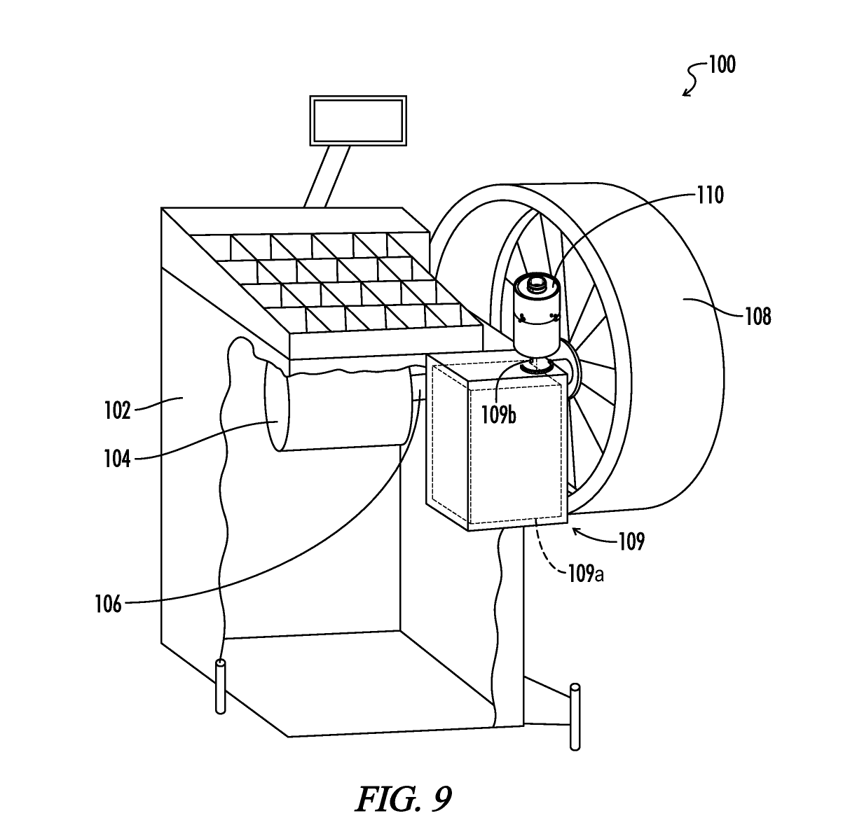

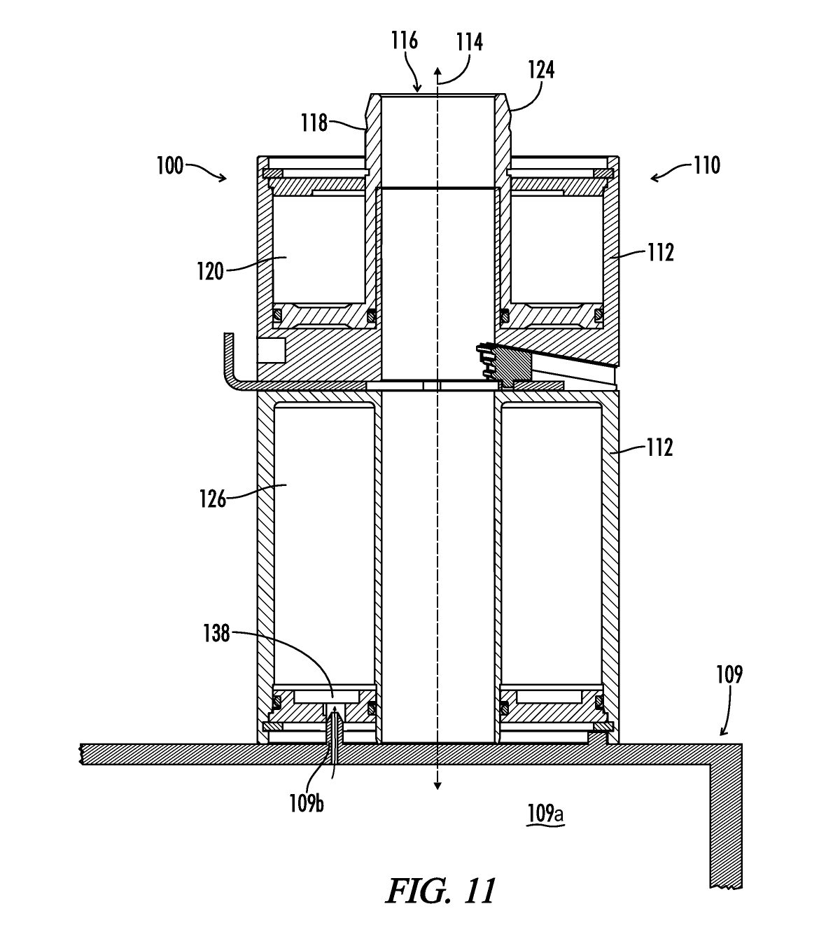

Another aspect of the present invention is a wheel service apparatus including a pneumatic nut and a docking station for the pneumatic nut. An embodiment of a wheel service apparatus 100 is shown in FIG. 9. Wheel service apparatus 100 can include a base 102, a motor 104 mounted to base 102, and a rotary shaft 106 rotatably connected to motor 104. Wheel service apparatus 100 can include a pneumatic nut 110 similar to the pneumatic nut 10 previously described herein. As shown in FIG. 11, pneumatic nut 110 can include a body 112 having an axis 114 and an aperture 116 through body 112 along axis 114. Aperture 116 can be shaped to receive the rotary shaft of wheel service apparatus 100. A first chamber 120 can be located in body 112, and a second chamber 126 can be located in body 112. A pneumatic inlet 138 can be communicated with second chamber 112. A piston 118 can be movable disposed in first chamber 120 between a retracted position and an extended position, piston 118 having a piston rod 124 extending out from first chamber 120 in a direction substantially parallel to axis 114. Piston 118 can move from the retracted position to the extended position when a pressure from second chamber 126 is supplied to first chamber 120.

Referring again to FIG. 9, a wheel and tire assembly 108 can be placed on rotary shaft 106 and pneumatic nut 110 can be used to clamp wheel and tire assembly 108 in a manner as previously described herein. Once wheel and tire assembly 108 is clamped to rotary shaft 106, motor 104 can rotate rotary shaft 106 and thereby rotate wheel and tire assembly 108 to perform a variety of wheel service operations.

As previously described, in some embodiments the second chamber 126 can be charged or pressurized before pneumatic nut 110 is placed on rotary shaft 106 such that a pneumatic supply line does not have to be connected to pneumatic nut 110 while pneumatic nut 110 is on rotary shaft 106. To facilitate the charging or pressurization of the second chamber 126, in some embodiments wheel service apparatus 100 can include a docking station 109 located on base 102. Docking station 109 can include a pneumatic supply 109a and a nozzle 109b communicated with pneumatic supply 109a. Nozzle 109b can be configured to be selectively coupled to pneumatic inlet 138 of pneumatic nut 110, as shown in FIG. 11.

Once a wheel and tire assembly is placed on the rotary shaft and pneumatic nut 110 is clamped to the rotary shaft, second chamber 126 can be discharged as previously described herein to clamp the wheel and tire assembly to the rotary shaft. Upon completion of the wheel service operation, pneumatic nut 110 can be removed from rotary shaft and placed on docking station 109 with nozzle 109b inserted into pneumatic inlet 138. Gas from the pneumatic supply 109a can then be supplied to second chamber 126 in order to recharge or pressurize second chamber 126 via pneumatic inlet 138 while an operator removes the first wheel and tire assembly and places another wheel and tire assembly on the rotary shaft. Pneumatic nut 110 can then be removed from docking station 109 and inserted again onto the rotary shaft to clamp the next wheel and tire assembly. Docking station 109 can help increase the efficiency and ease of the wheel service operation as pneumatic supply 109a for recharging pneumatic nut 110 is readily available nearby on base 102, and pneumatic nut 110 can be recharged while an operator is switching out wheel and tire assemblies on the rotary shaft. Such a system can help eliminate the need for an operator to handle a pneumatic line altogether.

Pneumatic supply 109a in some embodiments can be a pneumatic tank containing pressurized gas that is housed within docking station 109. When gas in the tank is depleted, the tank can be switched out for a new full tank. In other embodiments, pneumatic supply 109a can be pneumatic supply line which can be connected to the wheel service apparatus 100, the pneumatic supply line being connected to the docking station 109 and communicated with nozzle 109b. In some embodiments, pneumatic supply 109a can be configured to pressurize second chamber 126 to a pressure between about 100 PSI and about 200 PSI. In some embodiments, pneumatic supply 109a can be configured to pressurize second chamber 126 to about 150 PSI.

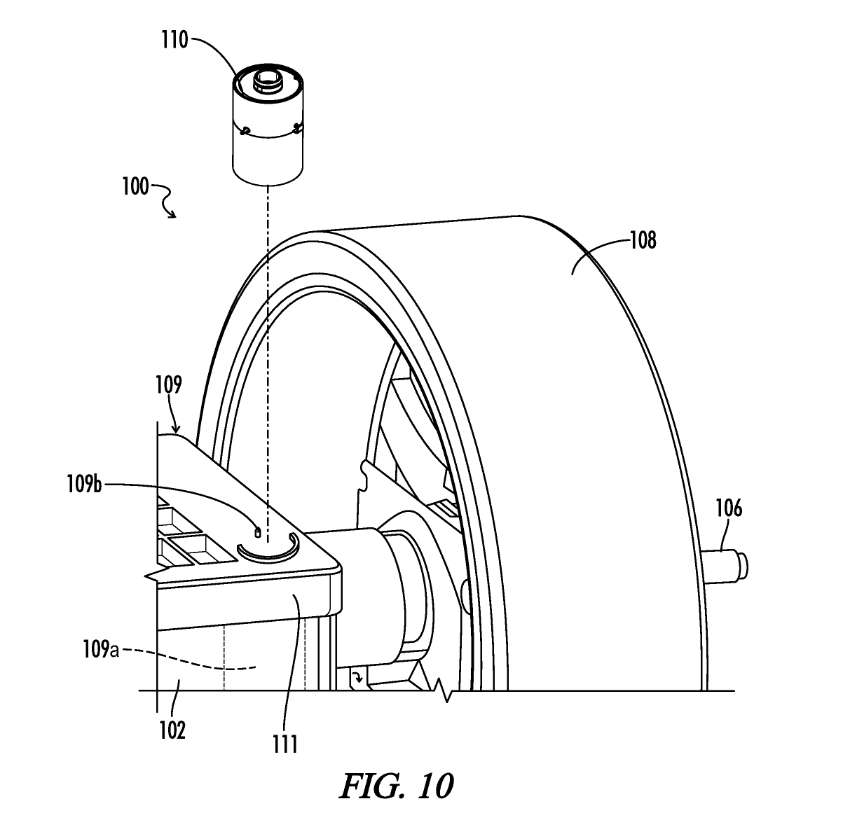

In some embodiments, as shown in FIG. 9, docking station 109 can be a separate unit that is connected or attached to base 102. As such, existing wheel service devices can be retrofitted with a docking station 109 to charge the second chamber of pneumatic nut 110. In other embodiments, as shown in FIG. 10, docking station 109 can be integrated into base 102, with nozzle 109b being incorporated into a weight tray 111 of base 102, and pneumatic supply 109a being housed within base 102.

Thus, although there have been described particular embodiments of the present invention of a new and useful Pneumatic Wheel Clamping Apparatus For A Wheel Service Machine it is not intended that such references be construed as limitations upon the scope of this invention except as set forth in the following claims.

What is claimed is:

1. A pneumatic nut apparatus for use on a rotary shaft of a wheel service machine, the pneumatic nut apparatus comprising:
a body having an axis and an aperture through the body along the axis, the aperture shaped to receive the rotary shaft;
a first chamber located in the body;
a second chamber located in the body;
a pneumatic inlet communicated with the second chamber, the pneumatic inlet configured to couple to a pneumatic supply line; and
a piston movably disposed in the first chamber between a retracted position and an extended position, the piston movable from the retracted position to the extended position when a pressure from the second chamber is supplied to the first chamber.

2. The apparatus of claim 1, further comprising a valve disposed on the body, the valve movable between a first position and a second position, the valve configured to substantially prevent fluid communication between the first and second chambers when the valve is in the first position and to allow fluid communication between the first and second chambers when the valve is in the second position.

3. The apparatus of claim 2, wherein the valve communicates the first chamber with an exterior of the apparatus when the valve is in the first position, and the valve is configured to substantially prevent communication between the first chamber and the exterior of the apparatus when the valve is in the second position.

4. The apparatus of claim 1, further comprising a spring disposed in the first chamber, the spring biasing the piston in the retracted position.

5. The apparatus of claim 1, further comprising a clamp assembly disposed on the body, the clamp assembly configured to selectively secure the body to the rotary shaft.

6. The apparatus of claim 5, wherein the clamp assembly further comprises a plate movably disposed on the body between an engaged position and a disengaged position with the rotary shaft when the rotary shaft is positioned in the aperture.

7. The apparatus of claim 6, wherein:
the plate further comprises a push button extending outward from the body; and
the clamp assembly further comprises a clamp spring disposed between the push button and the body, the clamp spring biasing the push button in a raised position and the plate in the engaged position, the push button configured to be depressed to move the plate from the engaged position to the disengaged position.

8. The apparatus of claim 6, wherein:
the rotary shaft is threaded; and
the plate further comprises one or more teeth configured to engage threads on the rotary shaft.

9. The apparatus of claim 1, wherein the pneumatic inlet further comprises a one-way check valve configured to prevent gases from exiting the second chamber.

10. The apparatus of claim 1, wherein the piston rod has a tapered distal end extending out from the first chamber.

11. A pneumatic nut apparatus for use on a rotary shaft of a wheel service machine, comprising:
a body having an axis and an aperture through the body along the axis, the aperture shaped to receive the rotary shaft;
a first chamber located in the body;
a second chamber located in the body;
a valve positioned between the first chamber and the second chamber, the valve configured to selectively communicate the first and second chambers;
a pneumatic inlet communicated with the second chamber, the pneumatic inlet configured to couple to a pneumatic supply line; and
a piston movably disposed in the first chamber between a retracted position and an extended position, the piston configured to move from the retracted position to the extended position when the valve communicates the first chamber with the second chamber and a pressure from the second chamber is supplied to the first chamber.

12. The apparatus of claim 11, wherein the valve is disposed on the body between the first and second chambers, the valve movable between a first position and a second position, the valve configured to substantially prevent fluid communication between the first and second chambers in the first position and to allow fluid communication between the first and second chambers in the second position.

13. The apparatus of claim 11, further comprising a clamp assembly disposed on the body, the clamp assembly including a plate movable between an engaged position and a disengaged position with the rotary shaft when the rotary shaft is positioned in the aperture in the body, the plate configured to prevent axial movement of the body on the rotary shaft when the plate is in the engaged position.

14. The apparatus of claim 11, wherein:
the piston further comprises a piston head disposed in the first chamber; and
the apparatus further comprises a spring positioned between the piston head and the body, the spring biasing the piston in the retracted position.

15. A wheel service apparatus comprising:
a base;
a motor mounted on the base;
a rotary shaft coupled to the motor; and
a pneumatic nut comprising
a body having an axis and an aperture through the body along the axis, the aperture shaped to receive the rotary shaft;
a first chamber located in the body;
a second chamber located in the body;
a pneumatic inlet communicated with the second chamber; and
a piston movably disposed in the first chamber between a retracted position and an extended position, the piston configured to move from the retracted position to the extended position when a pressure from the second chamber is supplied to the first chamber.

16. The apparatus of claim 15, further comprising a docking station located on the base, the docking station including a pneumatic supply and a nozzle communicated with the pneumatic supply, the nozzle configured to be selectively coupled to the pneumatic inlet of the pneumatic nut.

17. The apparatus of claim 16, wherein the docking station is a separate unit attached to the base.

18. The apparatus of claim 16, wherein the docking station is integrated into the base.

19. The apparatus of claim 16, wherein the docking station is configured to pressurize the second chamber to a pressure between about 100 PSI and about 200 PSI when the nozzle is coupled to the pneumatic inlet.

20. The apparatus of claim 15, wherein the pneumatic nut further comprises a valve positioned between the first chamber and the second chamber, the valve selectively communicating the first chamber with the second chamber.
